(19) United States
(12) Patent Application Publication
(10) Pub. No.: US 2008/0098912 A1
(43) Pub. Date: May 1, 2008

(54) Process and compound for producing printed design creating three-dimensional visual effect

(75) Inventor: Ho-Cheng Tai, Sin Jhuang City (TW)

Correspondence Address: BRUCE H. TROXELL, SUITE 1404, 5205 LEESBURG PIKE, FALLS CHURCH, VA, 22041, US

(73) Assignee: SANG BROLI COMPANY LIMITED

(21) Appl. No.: 11/589,308

(22) Filed: Oct. 30, 2006

(51) Int. Cl. B41M 1/00; C09D 11/02

(52) U.S. Cl. 101/130; 106/31.92

(57) ABSTRACT

In a process for producing a printed design creating 3D visual effect, a compound consisting of a printing ink blended with magnetic particles is used. The printing ink containing the magnetic particles is applied onto a printing plate on a printing apparatus, and a tool capable of producing a required magnetic force is positioned at a predetermined area of the applied printing ink, so that the magnetic particles in the printing ink are attracted and gathered to form ups and downs in the area and create a 3D visual effect.

### FIELD OF THE INVENTION

The present invention relates to a printed design creating three-dimensional (3D) visual effect, and more particularly to a process and compound for producing a printed design creating 3D visual effect through an interaction between magnetic particles and a magnetic body.

### BACKGROUND OF THE INVENTION

Conventional printing techniques include silk screen printing, automatic plane screen printing, pad printing, etc. All these printing techniques use mono or multiple colors to print and create only a two-dimensional flat visual effect, and therefore fail to meet the nowadays requirements for showing novel appearances by effectively upgrading a product's visual impression or creating a 3D visual effect. With the wide application of computerized equipment, the color separation in printing process is now carried out using a computer, and a gray scale is employed in printing to present a 3D effect. However, the computerized printing equipment is expensive to largely increase the cost of printing, while the simulated 3D effect is limited.

### SUMMARY OF THE INVENTION

A primary object of the present invention is to provide a process and a compound for producing a printed design creating 3D visual effect through an interaction between magnetic particles and a magnetic body.

To achieve the above and other objects, the compound of the present invention consists of a printing ink blended with magnetic particles, and the process of the present invention includes the steps of applying the printing ink containing magnetic particles onto a printing plate on a printing apparatus, and positioning a tool capable of producing a required magnetic force at a predetermined area of the applied printing ink, so that the magnetic particles in the area are attracted and gathered to form ups and downs in the area and create a 3D visual effect.

The compound of the present invention consists of 65˜95 wt % of printing ink, and 5˜15 wt % of magnetic particles. Preferably, the printing ink is added with dyes to adjust the color thereof.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 shows the mutual relation between magnetic particles in a printing ink of the present invention and a magnetic body;

FIG. 2 shows the structure of a tool used in the present invention to produce magnetic force;

FIGS. 3 and 4 show a process of the present invention for producing printed design creating 3D visual effect, in which a top-attraction tool is used;

FIG. 5 shows a process of the present invention for producing printed design creating 3D visual effect, in which a bottom-attraction tool is used;

FIG. 6 is a flowchart showing the steps included in the process of the present invention for producing printed design creating 3D visual effect; and

FIG. 7 shows one example of the printed designs produced using the process and the compound of the present invention.

### DETAILED DESCRIPTION OF THE PREFERRED EMBODIMENTS

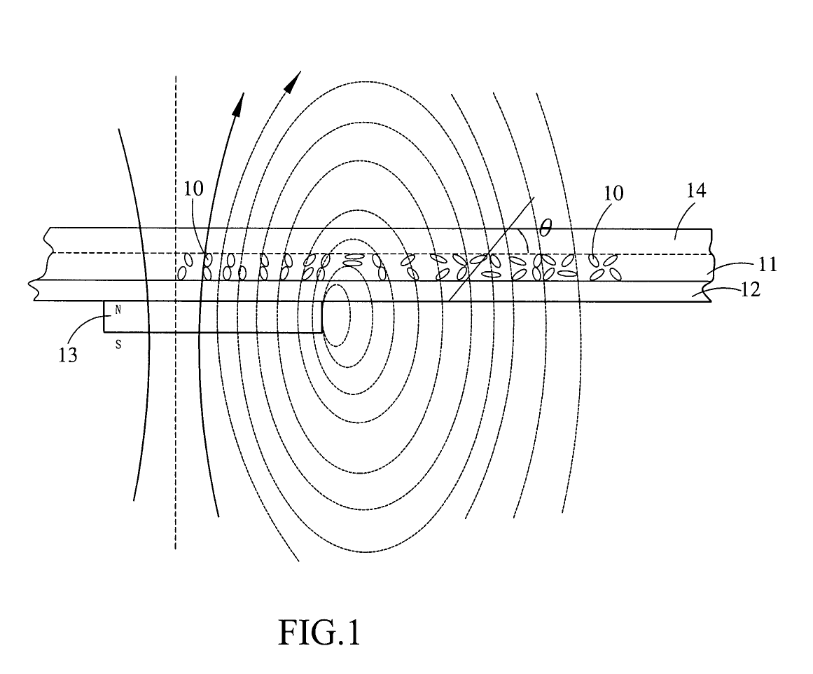

Please refer to FIG. 1 that shows the mutual relation between magnetic particles in a printing ink of the present invention and a magnetic body. As shown, when a printing ink 11 blended with magnetic particles 10 is applied onto a printing plate 12, and a magnetic body 13 is positioned beneath an area of the applied printing ink 11, at where a three-dimensional (3D) surface is to be created, the magnetic particles 10 in the still wet printing ink 11 are attracted by the magnetic body 13 to gather in the area and create ups and downs therein to show a 3D visual effect.

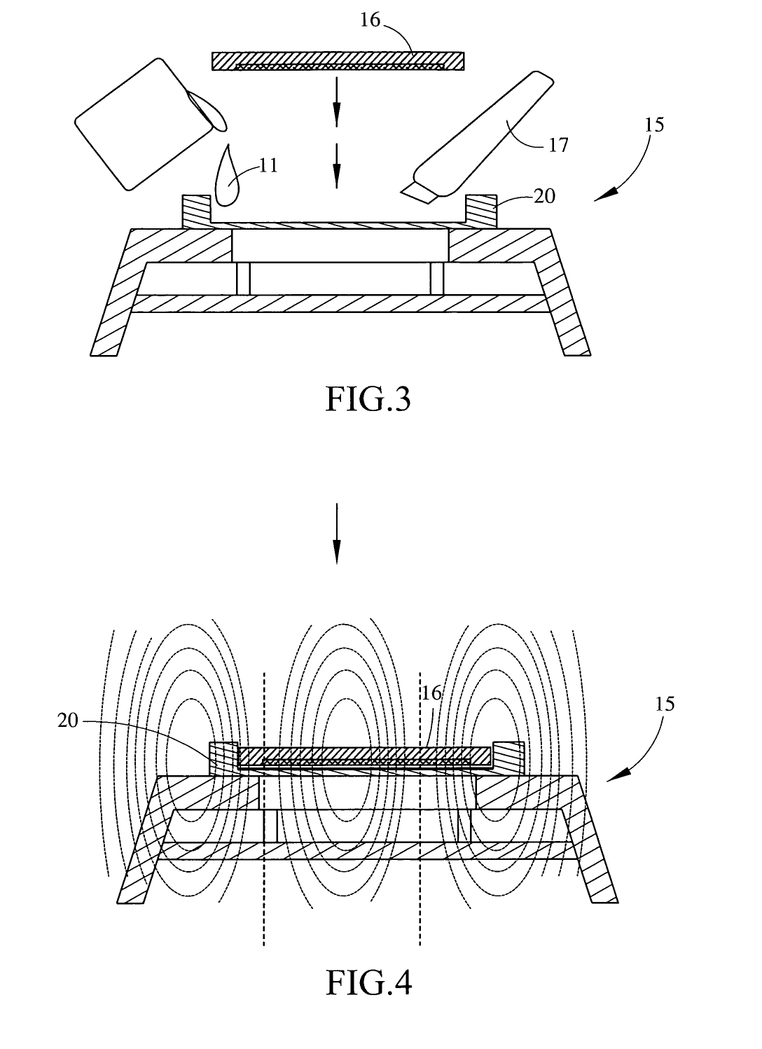

The printing process creating 3D visual effect according to the present invention is different from the conventional printing techniques in that the present invention may be implemented with an existing printing apparatus 15 (see FIGS. 3, 4, and 5) without the need of designing a new one. On the printing apparatus 15, a compound disclosed in the present invention, which is a type of printing ink, for producing printed design creating 3D visual effect cooperates with a magnetic tool 16, so that magnetic particles 10 contained in the compound of the present invention are attracted and gathered by the magnetic tool 16 to create the 3D visual effect.

Preferably, the compound of the present invention includes 65˜95 wt % of printing ink 11, 5˜15 wt % of magnetic particles 10, and 5˜30 wt % of dyes, which are well blended. The magnetic particles 10 added in the printing ink 11 react to magnetic force when the printing ink 11 is still wet, and are differently distributed under the magnetic force to create the 3D visual effect. Preferably, the magnetic particles 10 are iron oxide red (Fe₂O₃).

Another example of the compound of the present invention includes 65˜95 wt % of printing ink, and 5˜15 wt % of magnetic particles, which are well blended. When it is desired to create a black and white printed design, simply mix the printing ink 11 of a primary color with the magnetic particles 10 directly.

The printing ink 11 may contains polyvinyl, polyvinyl chloride, urethane resin, isophorone, cyclohexanone, phenyl alkyl solution, and ethylene glycol solution.

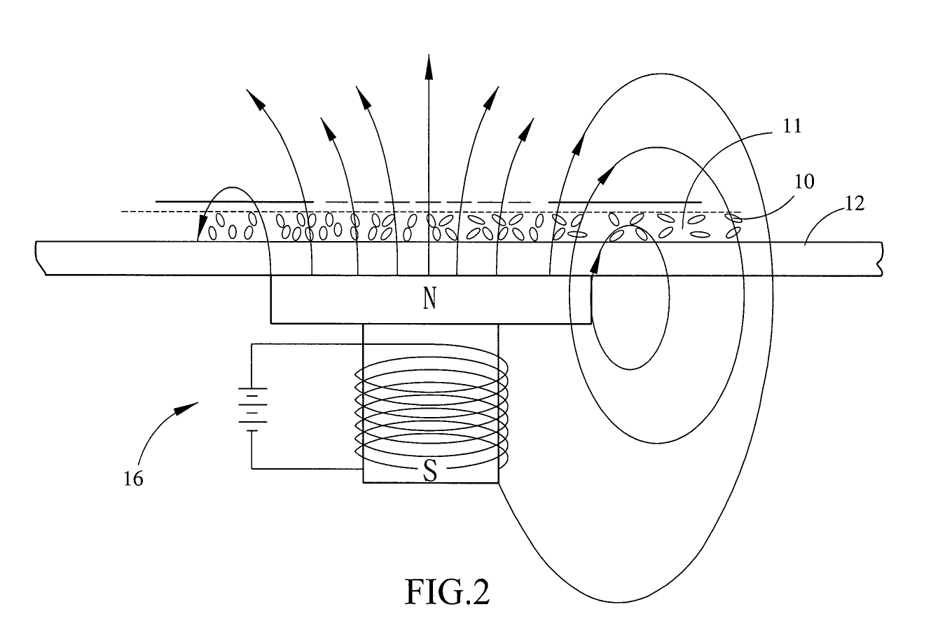

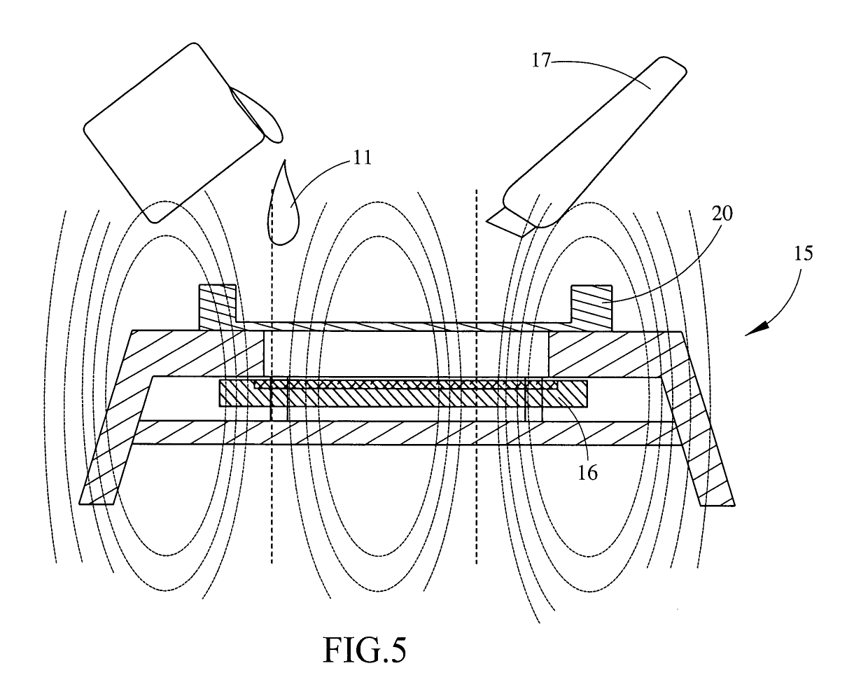

Please refer to FIG. 2 that shows the structure of a tool 16 used in the present invention to produce magnetic force. As shown, the tool 16 uses magnet or electric current to produce magnetic force of the same polarity or different polarities, or different intensity to cause changes in the distribution of the magnetic particles 10 in the printing ink 11. When the magnetic tool 16 is positioned below a printing plate, as shown in FIG. 5, the tool 16 is referred to as a bottom-attraction tool herein, which is able to produce failings on the applied printing ink 11 to create a 3D visual effect; and when the magnetic tool 16 is positioned above the printing plate, as shown in FIGS. 3 and 4, the tool 16 is referred to as a top-attraction tool herein, which is able to produce raisings on the applied printing ink 11 to create a 3D visual effect.

Please refer to FIG. 2. The magnetic tool 16 may include a winding and be supplied with electric current to produce the magnetic force. With this type of tool 16, it is possible to adjust a magnitude of the magnetic force produced, so as to create different 3D visual effects.

Before the printing ink 11 is applied onto the printing plate 12, a screen plate or a stencil plate is first positioned on the printing plate 12, so that the printing ink 11 is coated on the printing plate 12 according to the design or designs defined on the screen plate or the stencil plate. Since the printing ink 11 has magnetic particles 10 blended therewith, it is possible to create a 3D visual effect at a predetermined area of the applied printing ink 11 on the printing plate 12 through arrangement of the magnetic body 13 below the printing plate 12 corresponding to the predetermined area. Preferably, such printing is performed using a printing apparatus 15, which includes a scraper 17 (see FIGS. 3 and 5), a pad printer, or the like.

When the printing ink 11 having created the 3D visual effect has become dried, a protective layer 14 may be applied over the finished 3D printed design, as shown in FIG. 1. The protective layer 14 may be formed by, for example, a polyurethane (PU) varnish coating, or an ultraviolet-cured (UV) varnish coating to protect the printed design and highlight the 3D visual effect.

Please refer to FIGS. 3 and 4, which show a process of the present invention for producing printed design creating 3D visual effect using a top-attraction tool 16. First, an amount of printing ink 11 containing magnetic particles 10 is applied onto a screen plate 20, and a top-attraction tool 16 is selected according to a desired final design appearance. Then, perform the printing using the required screen plate or stencil plate and the magnetic-particle-containing printing ink 11 on a printing apparatus 15. When the printing is completed, the top-attraction tool 16 is closed onto an upper side of the finished printed design to change the arrangement of the magnetic particles 10 in the still wet printing ink 11 and thereby produces raisings on the applied printing ink 11. The tool 16 and the finished printed design are kept still for 15 to 20 seconds to allow the forming of the desired 3D design. The tool 16 is then removed from the screen or stencil plate, and the finished printed design is subjected to a drying process to dry the printing ink 11.

FIG. 5 shows a process of the present invention for producing printed design creating 3D visual effect using a bottom-attraction tool 16. First, an amount of printing ink 11 containing magnetic particles 10 is applied onto a screen plate 20, and a bottom-attraction tool 16 is selected according to a desired final design appearance. Then, an object to be printed is positioned in the bottom-attraction tool 16, and the printing is performed using the required screen plate or stencil plate and the magnetic-particle-containing printing ink 11 on a printing apparatus 15. When the printing is completed, the finished printed design is kept still on the tool 16 for 15 to 20 seconds to allow the forming of the desired 3D design. The finished printed design is then removed from the tool 16 and subjected to a drying process to dry the printing ink 11.

The design of a printing for creating a 3D visual effect may be started once an appearance designer has decided the final product appearance. Then, the direction, polarity, and strength of the magnetic force to be produced are determined according to the location at where the 3D visual effect is to be created, and the magnetic tool 16 is developed accordingly. And, the printing ink 11 blended with an adequate amount of magnetic particles 10, which is determined according to the required product appearance, and the suitable screen plate or stencil plate are prepared for printing on the printing apparatus 15.

The printing ink 11 having created a 3D visual effect is dried using a drying oven. Finally, a protective layer 14 is formed over the 3D surface of the dried printing ink 11. The material for the protective layer is selected depending on actual need, and may be PU paint, UV paint, or soft-touch paint. Alternatively, a varnish coating with high or low gloss may be used to form the protective layer 14 to not only protect the printed design, but also enhance the 3D visual effect.

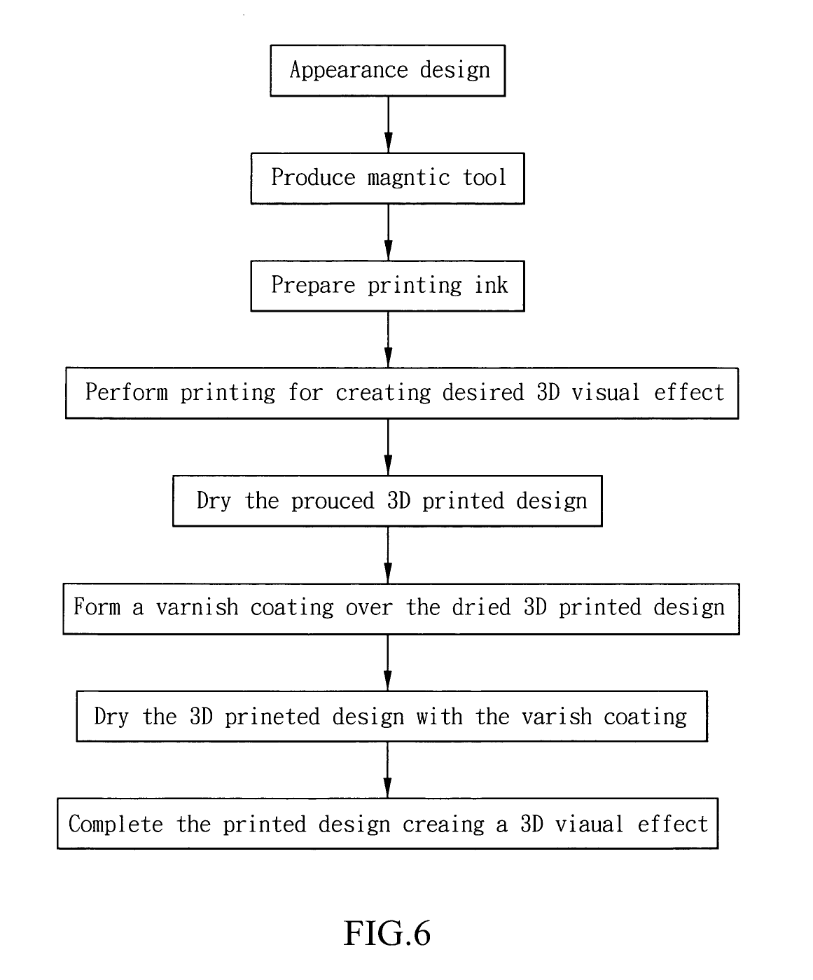

FIG. 6 is a flowchart showing the steps included in the process of the present invention for producing a printed design creating 3D visual effect. In the first step, the design of a printing for creating a 3D visual effect is started after an appearance designer has decided the final appearance requirement. In the second step, the direction, polarity, and strength of the magnetic force to be produced are determined according to the location at where the 3D visual effect is to be created, and a suitable magnetic tool is developed accordingly. In the third step, the printing ink blended with an adequate amount of magnetic particles determined according to the required appearance is prepared. In the fourth step, a suitable screen plate or stencil plate is prepared to perform printing on a printing apparatus using the prepared printing ink; and the magnetic tool prepared in the step 2 is used to attract the magnetic particles in the printing ink to create the desired 3D visual effect. In the fifth step, the magnetic tool is removed, and the produced printed design is dried in a drying oven. In the sixth step, a PU or UV varnish coating is applied over the dried 3D printed design to form a protective layer. In the seventh step, the 3D printed design with the protective layer is dried in the drying oven again to complete the printed design creating a 3D visual effect.

In practical implementation of the present invention, a plate film, a screen plate, and a magnetic tool with magnets in the required number, at required locations, and having required magnetic strength are produced according to the actually required appearance. Meanwhile, the printing ink is prepared according to actual need to contain 65˜95 wt % of ink, 5˜15 wt % of magnetic particles, and 5˜30 wt % of dyes, which are well blended. The PU varnish coating is also prepared according to actual need. To print, the prepared printing ink is applied over the screen plate and a squeegee is moved to and fro on the printing ink for two to four times. The applied printing ink is then kept still for 15 to 20 seconds, so that the magnetic particles in the printing ink are affected by the magnetic force produced by the magnetic tool to create the desired 3D appearance. When the created appearance is confirmed as correct, the printed design is positioned in the drying oven for 20 to 30 minutes to dry the printing ink. The prepared PU varnish coating is then applied over the dried printing ink to form the protective layer on the 3D appearance. The printed design is then positioned in the drying oven for another 20 to 30 minutes to dry the PU varnish coating. The whole process for producing a printed design creating 3D visual effect is then completed.

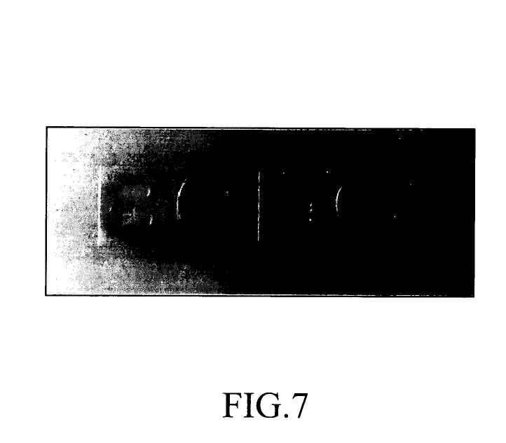

A drawing showing one example of the printed designs produced using the process and the compound of the present invention is submitted along with the present application for reference as shown in FIG. 7.

What is claimed is:

1. A process for producing a printed design creating 3D visual effect, comprising the steps of applying a printing ink containing magnetic particles onto a printing plate; and positioning a magnetic body corresponding to a predetermined area of the applied printing ink when the printing ink is still wet; such that the magnetic particles in the printing ink are attracted by the magnetic body to gather in the predetermined area to form ups and downs in the area, creating a 3D visual effect.

2. A process for producing a printed design creating 3D visual effect, comprising the steps of deciding a final product appearance by an appearance designer and starting the designing of a printing for creating a 3D visual effect; preparing a tool for producing magnetic force according to a location at where a 3D visual effect is to be created; preparing a printing ink blended with an adequate amount of magnetic particles, and applying the prepared printing ink onto a desired screen plate or stencil plate, and performing the designed printing on a printing apparatus; and removing the magnetic tool and drying the produced printed design in a drying oven.

3. The process for producing a printed design creating 3D visual effect as claimed in claim 2, further comprising the steps of applying a layer of PU varnish coating or UV varnish coating over the dried printing ink, and drying the varnish coating in the drying oven.

4. A compound for producing a printed design creating 3D visual effect, comprising a material consisting of 65˜95 wt % of printing ink, and 5˜15 wt % of magnetic particles well blended with the printing ink.

5. The compound for producing a printed design creating 3D visual effect as claimed in claim 4, wherein said material further including 5˜30 wt % of dyes.

6. The compound for producing a printed design creating 3D visual effect as claimed in claim 4, wherein said magnetic particles are iron oxide red (Fe₂O₃).

7. The compound for producing a printed design creating 3D visual effect as claimed in claim 4, wherein said printing ink contains polyvinyl, polyvinyl chloride, urethane resin, isophorone, cyclohexanone, phenyl alkyl solution, and ethylene glycol solution.
